(19) United States
(12) Patent Application Publication
(10) Pub. No.: US 2023/0103867 A1
(43) Pub. Date: Apr. 6, 2023

(54) APPLICATION OF MODULAR GEOTHERMAL POWER PLANT FOR DISTRIBUTED NETWORK OF ELECTRICAL VEHICLE CHARGING STATIONS, DECENTRALIZED POWER GRIDS, AND EXHAUSTED OIL OR GAS WELLS

(71) Applicant: Ruslan Asfandiyarov, 1003 Lausanne (CH)

(72) Inventor: Ruslan Asfandiyarov, 1003 Lausanne (CH)

(21) Appl. No.: 17/937,987

(22) Filed: Oct. 4, 2022

Related U.S. Application Data
(60) Provisional application No. 63/252,248, filed on Oct. 5, 2021.

(30) Foreign Application Priority Data
Oct. 4, 2022 (IB) PCT/IB2022/059480

(51) Int. Cl. F24T 10/20; B60L 53/30

(52) U.S. Cl. CPC F24T 10/20; B60L 53/305; F24T 2010/56

(57) ABSTRACT

A system may provide for a plurality of modular power plants in operable communication with one another, each individual power plant being at least partially disposed within a new well or exhausted oil or gas well or conventional geothermal well or along the length of a well. Each modular power plant may be considered a node within the network and may include multiple means of interconnectivity such that temporary loss or failure of a single node does not interfere with the operability of the remaining modular power plants. The system may be constructed and arranged for a decentralized power grid for residential, commercial, or industrial applications including electric vehicle charging or the like.

### CROSS REFERENCE TO RELATED APPLICATIONS

This application claims the benefit of U.S. Provisional Patent Application No. 63/252,248 filed Oct. 5, 2021.

### TECHNICAL FIELD

The embodiments generally relate to power plants applied to exhausted or new oil or gas wells for harvesting geothermal heat to provide electricity generation for decentralized power grids, and distributed network of electricity consumers such as electrical vehicle charging stations.

### BACKGROUND

It is estimated that over seventy percent of greenhouse gases can be traced back to energy production. The increased use of renewable energy sources is the key to a more sustainable future.

A need for environmentally friendly, decentralized power grids that may make use of new geothermal wells or exhausted gas or oil wells exists to overcome dependency on fossil fuels and to create resilient power grids.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The system generally relates to a system of modular sustainable electricity production plants in operative communication with one another on an industrial scale anywhere in the world, by optionally taking advantage of existing but exhausted or abandoned oil or gas exhausted wells or new drilled geothermal wells. The system may be implemented within said exhausted wells to repurpose the exhausted wells for efficient, clean energy production.

In general, the system may include repurposing an exhausted well or plurality of exhausted wells and newly drilled wells by disposing a plurality of power plants, such as geothermal power plants, installed in multiple cavities on the bottom of the exhausted or newly drilled well to convert the geothermal heat directly to electricity. A surface infrastructure may consist of electricity distribution racks to provide operable communication between power plants. The surface infrastructure can be placed underground at shallow depths keeping it completely out of sight.

In general, these systems can be connected together and to other consumers to create a distributed and decentralized power grid. Similar systems can be adapted for other consumers directly such as small or large communities, critical infrastructure, industrial facilities, remote and military infrastructures, or private households.

In one aspect, the system may include a modular electricity generation power plant disposed within a drilled, bored, or drilled well or an exhausted well, constructed and arranged to harvest non-volcanic geothermal heat based on thermoelectric technology.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and features thereof will be more readily understood by reference to the following detailed description when considered in conjunction with the accompanying drawings, wherein:

FIG. 1 illustrates a simplified system diagram of one variation of a modular geothermal power plant for distributed network of electrical vehicle charging stations, decentralized power grids, and exhausted oil or gas wells;

FIG. 2 illustrates a simplified system diagram of one variation of a modular geothermal power plant for distributed network of electrical vehicle charging stations, decentralized power grids, and exhausted oil or gas wells; and

FIG. 3 illustrates a simplified system diagram of one variation of a modular geothermal power plant for distributed network of electrical vehicle charging stations, decentralized power grids, and exhausted oil or gas wells.

The drawings are not necessarily to scale, and certain features and certain views of the drawings may be shown exaggerated in scale or in schematic in the interest of clarity and conciseness and should not be considered limiting.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the system may provide for a system of modular power plants in operable communication with one another, each individual power plant being at least partial disposed within an exhausted well or along the length of an exhausted well. Each powerplant may include power modules connected in series to create desired voltage output and in parallel for required power. Each module may include thermoelectric elements such as TEGs with a hot-side facing outwards and a cold-side exposed to cooling.

In general, the system may provide for powering electric vehicle charging stations without the need for connection to a central power grid. According to some embodiments, the system may be standalone from a centralized power grid and may be in operable communication with at least one electric vehicle charging station. As a non-limiting example, each system may provide 5 KW of power to charge 20 cars simultaneously with 250 kW charging stations. These small power plants can be connected and to other consumers to create a distributed and decentralized power grid.

According to other embodiments, the system may be implemented as a plurality of nodes as part of a decentralized power grid containing a plurality of modular power plant systems in operable communication with one another to satisfy the energy needs of consumer bases. Critical, remote, and military infrastructure can benefit significantly from such self-sufficient, modular power plants. Hospitals, airports, military installations require reliable and independent source of base load energy, and such power plants can satisfy this need. Industrial facilities can also be powered with such power plants making them more energy efficient and reducing carbon intensity of their processes. Large private households can also benefit from these types of power plants making them fully independent from a central grid.

According to some embodiments, the system may take advantage of existing, exhausted gas and oil wells by repurposing said wells to produce electricity. Re-purposing exhausted oil & gas wells for electricity generation presents a significant opportunity for oil & gas producing countries to improve the energy efficiency of the oil extraction facilities. This way, they create additional green electricity generation capacity which can be used to power industrial facilities such as factories or manufacturing plants.

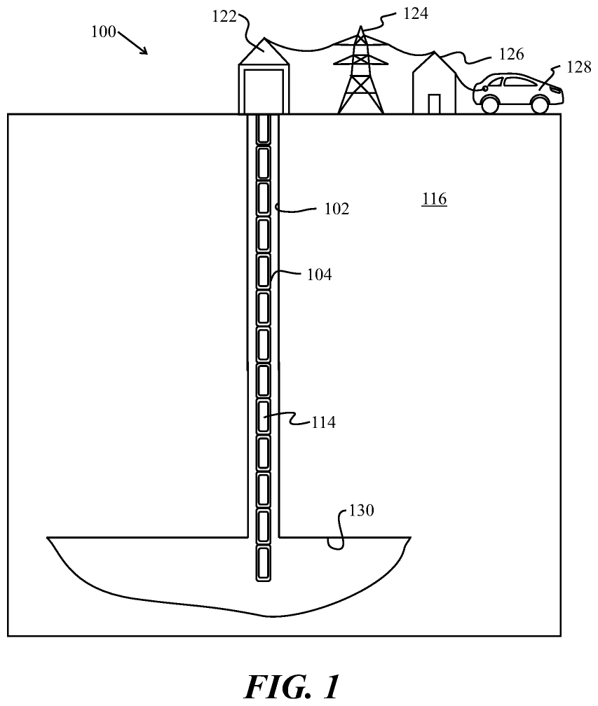

Referring to FIG. 1, a node of modular power plant system 100 may include a new or recently drilled well or exhausted well shaft 102 defined within a portion of the earth's crust 116 which has been dug or drilled prior to installation of the modular power plant system 100. The exhausted well shaft 102 may include an exhausted well bottom 130. As a non-limiting example, a plurality of modules 104 may include thermal energy conversion elements 114 that may be disposed in parallel within portions of the exhausted well 102 or in series with portions of the exhausted well bottom 130 or exhausted well shaft 102. The plurality of modules 104 may be in operable communication with surface infrastructure 122 in operable communication with an electricity distribution system 124 and end user electrical needs such as residential electricity needs 128.

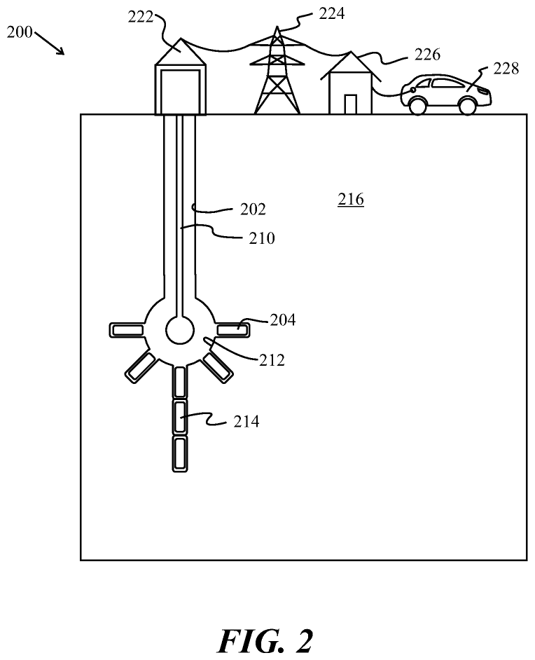

Referring to FIG. 2, a modular power plant system 200 may include a well shaft 102 defined within a portion of the earth's crust 116 which has been dug or drilled prior to installation of the modular power plant system 200. The well shaft 202 may include a well bottom 212. As a non-limiting example, thermal energy conversion modules 204 may be disposed in parallel within boreholes or in series within boreholes. The plurality of modules 204 may be in operable communication with surface infrastructure 222 which may be in operable communication with an electricity distribution system 224 and end user electrical needs 226 such as electric vehicle charging stations 128. Voltage may be communicated from the modules 204 to surface infrastructure 222 via power transmission lines 210. The modular power plant system 200 may include a plurality of modular power plants each in operable communication with at least one other modular power plant system such that a network modular power plant system is formed to provide distributed network of electrical vehicle charging stations and decentralized power grids.

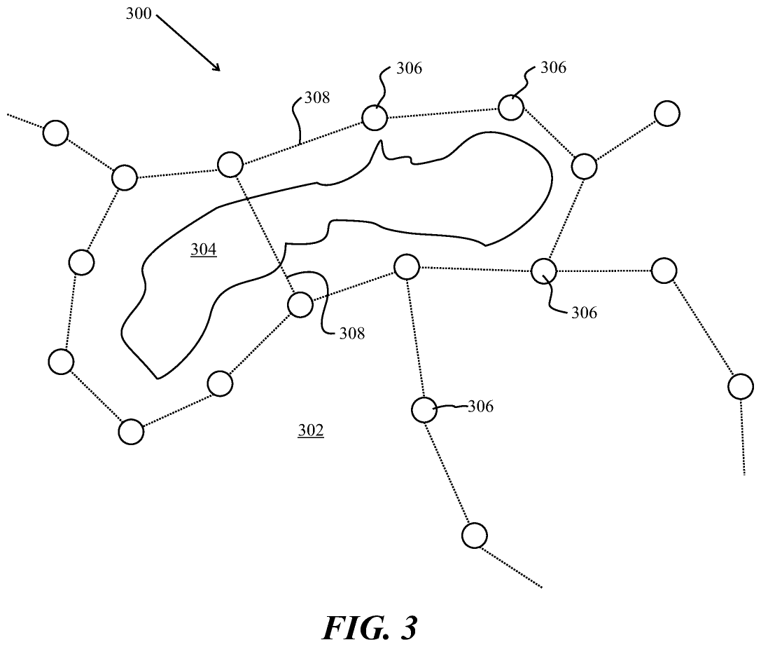

FIG. 3 depicts a simplified aerial view of a network modular power plant system 300 that may include a plurality of modular power plants 306 each in operable communication 308 with at least one other modular power plant system 306 such that a network modular power plant system 300 is formed on a body of land 302 or over or around or next to a body of water 304. Each modular power plant 306 may be considered a node within the network 300 and may include multiple means of interconnectivity such that temporary loss or failure of a single node does not interfere with the operability of the remaining modular power plants 306, thereby creating a redundant power supply system and network.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1 a, node of a modular power plant system may include an electricity distribution system; a surface infrastructure in operable communication with the electricity distribution system; at least one well shaft defined by a portion of the earth's crust and may include a well bottom; at least one thermal energy conversion module may include thermal energy conversion elements disposed within at least a portion of the at least one well shaft and wherein the at least one thermal energy conversion module is in operable communication with the electricity distribution system, the surface infrastructure, and an end user electrical need.

Variation 2 may include a node of modular power plant system as in variation 1, wherein the at least one thermal energy conversion module is a plurality of thermal energy conversion modules.

Variation 3 may include a node of modular power plant system as in variation 1 or 2, wherein the well shaft is at least one of an exhausted oil, gas, or conventional geothermal well shaft.

Variation 3 may include a node of modular power plant system as in any of variations 1 through 2, wherein the well shaft is a newly drilled well.

Variation 4 may include a node of modular power plant system as in any of variations 1 through 3, wherein the plurality of thermal energy conversion modules are disposed in parallel within a portion of the at least one well shaft.

Variation 5 may include a node of modular power plant system as in any of variations 1 through 4, wherein the plurality of thermal energy conversion modules are disposed in series within a portion of the well bottom.

Variation 6 may include a node of modular power plant system as in any of variations 1 through 5, wherein the plurality of thermal energy conversion modules are disposed partially in series within a portion of the well bottom and in parallel within a portion of the at least one well shaft.

Variation 7 may include a node of modular power plant system as in any of variations 1 through 6, wherein the plurality of thermal energy conversion modules each include a thermoelectric generator may include a first surface and a second surface, the thermal electric generator being constructed and arranged to convert temperature difference between the first surface and the second surface into electrical energy; at least one DC collector constructed and arranged to collect electrical energy from the thermoelectric generator; and at least one DC to AC converter constructed and arranged to receive DC voltage from the DC collector.

Variation 8 may include a network modular power plant system that may include an electricity distribution system; a surface infrastructure in operable communication with the electricity distribution system; at least one well shaft defined by a portion of the earth's crust and may include a well bottom; a plurality of nodes. Each node individually may include at least one thermal energy conversion module may include a plurality of thermal energy conversion elements, the at least one thermal energy conversion module being disposed within at least a portion of the at least one well shaft well; and wherein the plurality of nodes are in operable communication with at least the electricity distribution system, the surface infrastructure, or an end user electrical need.

Variation 10 may include a network modular power plant system as in variation 9 wherein the at least one thermal energy conversion module includes a thermoelectric generator may include an outer surface and an inner surface and defining a cavity therein, the thermal electric generator being constructed and arranged to convert temperature difference between the outer surface and the inner surface into electrical energy.

Variation 11 may include a network modular power plant system as in variation 9 or 10 wherein the plurality of nodes are in operable communication with at least one other node.

Variation 12 may include a network modular power plant system as in any of variations 9 through 11 wherein the plurality of nodes are in operable communication with at least one other node.

Variation 13 may include a network modular power plant system as in any of variations 9 through 12 wherein each node in the plurality of nodes further includes at least one of a closed or open loop cooling system constructed and arranged to cool the at least one thermal energy conversion module.

Variation 14 may include a network modular power plant system as in any of variations 9 through 13 wherein the plurality of nodes are in operable communication with one another to provide a redundant power supply.

According to variation 15, a network modular power plant system may include an electricity distribution system; and a plurality of nodes. Each node individually may include a surface infrastructure in operable communication with the electricity distribution system; at least one thermal energy conversion module may include a thermoelectric generator may include a first surface and a second surface, the thermal electric generator being constructed and arranged to convert temperature difference between the first surface and the second surface into electrical energy; and wherein the plurality of nodes are in operable communication with at least one of one another, the electricity distribution system, or the surface infrastructure to provide a redundant power supply.

Variation 16 may include a network modular power plant system as in variation 15, wherein the at least one thermal energy conversion module of the plurality of nodes are disposed within at least one of well shafts or well bottoms.

Variation 17 may include a network modular power plant system as in variation 15 or 16, wherein each node in the plurality of nodes is constructed and arranged to operably communicate electrical energy from the at least one thermal energy conversion module to the surface infrastructure to the electricity distribution system.

Variation 18 may include a network modular power plant system as in any of variations 15 through 17, wherein each node in the plurality of nodes further includes at least one of a closed or open loop cooling system constructed and arranged to cool the at least one thermal energy conversion module.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A node of a modular power plant system comprising:
an electricity distribution system;
a surface infrastructure in operable communication with the electricity distribution system;
at least one well shaft defined by a portion of the earth's crust and comprising a well bottom;
at least one thermal energy conversion module comprising thermal energy conversion elements disposed within at least a portion of the at least one well shaft and wherein the at least one thermal energy conversion module is in operable communication with the electricity distribution system, the surface infrastructure, and an end user electrical need.

2. A node of modular power plant system as in claim 1, wherein the at least one thermal energy conversion module is a plurality of thermal energy conversion modules.

3. A node of modular power plant system as in claim 1, wherein the well shaft is at least one of an exhausted oil, gas, or conventional geothermal well shaft.

4. A node of modular power plant system as in claim 1, wherein the well shaft is a newly drilled well.

5. A node of modular power plant system as in claim 1, wherein the plurality of thermal energy conversion modules are disposed in parallel within a portion of the at least one well shaft.

6. A node of modular power plant system as in claim 1, wherein the plurality of thermal energy conversion modules are disposed in series within a portion of the well bottom.

7. A node of modular power plant system as in claim 1, wherein the plurality of thermal energy conversion modules are disposed partially in series within a portion of the well bottom and in parallel within a portion of the at least one well shaft.

8. A node of modular power plant system as in claim 1, wherein the plurality of thermal energy conversion modules each comprise:
a thermoelectric generator comprising a first surface and a second surface, the thermal electric generator being constructed and arranged to convert temperature difference between the first surface and the second surface into electrical energy;
at least one DC collector constructed and arranged to collect electrical energy from the thermoelectric generator; and
at least one DC to AC converter constructed and arranged to receive DC voltage from the DC collector.

9. A network modular power plant system comprising:
an electricity distribution system;
a surface infrastructure in operable communication with the electricity distribution system;
at least one well shaft defined by a portion of the earth's crust and comprising a well bottom;
a plurality of nodes, each node individually comprising:
at least one thermal energy conversion module comprising a plurality of thermal energy conversion elements, the at least one thermal energy conversion module being disposed within at least a portion of the at least one well shaft well; and
wherein the plurality of nodes are in operable communication with at least the electricity distribution system, the surface infrastructure, or an end user electrical need.

10. A modular power plant system as in claim 9, wherein the at least one thermal energy conversion module comprises a thermoelectric generator comprising an outer surface and an inner surface and defining a cavity therein, the thermal electric generator being constructed and arranged to convert temperature difference between the outer surface and the inner surface into electrical energy.

11. A modular power plant system as in claim 9, wherein the plurality of nodes are in operable communication with at least one other node.

12. A modular power plant system as in claim 9, wherein the plurality of nodes are in operable communication with at least one other node.

13. A network modular power plant system as in claim 9, wherein each node in the plurality of nodes further comprises at least one of a closed or open loop cooling system constructed and arranged to cool the at least one thermal energy conversion module.

14. A modular power plant system as in claim 13, wherein the plurality of nodes are in operable communication with one another to provide a redundant power supply.

15. A network modular power plant system comprising:
an electricity distribution system;
a plurality of nodes, each node individually comprising:
a surface infrastructure in operable communication with the electricity distribution system;
at least one thermal energy conversion module comprising a thermoelectric generator comprising a first surface and a second surface, the thermal electric generator being constructed and arranged to convert temperature difference between the first surface and the second surface into electrical energy; and
wherein the plurality of nodes are in operable communication with at least one of one another, the electricity distribution system, or the surface infrastructure to provide a redundant power supply.

16. A network modular power plant system as in claim 15, wherein the at least one thermal energy conversion module of the plurality of nodes are disposed within at least one of well shafts or well bottoms.

17. A network modular power plant system as in claim 15, wherein each node in the plurality of nodes is constructed and arranged to operably communicate electrical energy from the at least one thermal energy conversion module to the surface infrastructure to the electricity distribution system.

18. A network modular power plant system as in claim 15, wherein each node in the plurality of nodes further comprises at least one of a closed or open loop cooling system constructed and arranged to cool the at least one thermal energy conversion module.
